(19) United States
(12) Patent Application Publication
(10) Pub. No.: US 2014/0153871 A1
(43) Pub. Date: Jun. 5, 2014

(54) OPTICAL COUPLING ELEMENT AND OPTICAL-ELECTRIC CONVERTING MODULE USING SAME

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/858,115

(22) Filed: Apr. 8, 2013

(30) Foreign Application Priority Data
Nov. 30, 2012 (TW) 101144874

(51) Int. Cl. G02B 6/32

(52) U.S. Cl. CPC G02B 6/32
USPC 385/33

(57) ABSTRACT

An optical coupling element includes a lower surface, an upper surface, and a side surface. The lower surface defines a first cavity. The first cavity includes a bottom portion. The bottom portion forms at least two first light coupling lenses. A diameter of each first light coupling lens is equal to d1. The upper surface faces away from the lower surface, and defines a second cavity. The second cavity includes a reflecting surface. The side surface perpendicularly connects to the lower surface. The side surface forms at least two second light coupling lenses. A diameter of each second light coupling lens is equal to d2, and d1>d2.

### BACKGROUND

1. Technical Field

The present disclosure relates to an optical coupling element and an optical-electric converting module using the same.

2. Description of Related Art

An optical coupling member typically includes a main body, two groups of light coupling lenses and a reflecting surface formed on the main body. The main body includes a first side surface and a second side surface perpendicular to the first side surface. The two groups of light coupling lenses are formed on the first side surface and the second side surface. Precise alignment of the lenses is very important, thus eccentricity measuring of the two groups of light coupling lenses is required. However, an eccentricity measuring method usually includes first measuring one group of light coupling lenses formed on the first side surface, and then measuring the other group of light coupling lenses formed on the second side surface, this is time-consuming.

Therefore, it is desirable to provide an optical coupling element and an optical-electric converting module which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of an optical-electric converting module which includes an optical coupling element, according to an exemplary embodiment.

FIG. 2 is an exploded, isometric view of the optical-electric converting module of FIG. 1.

FIG. 3 is a cross-sectional view taken along line of FIG. 1.

### DETAILED DESCRIPTION

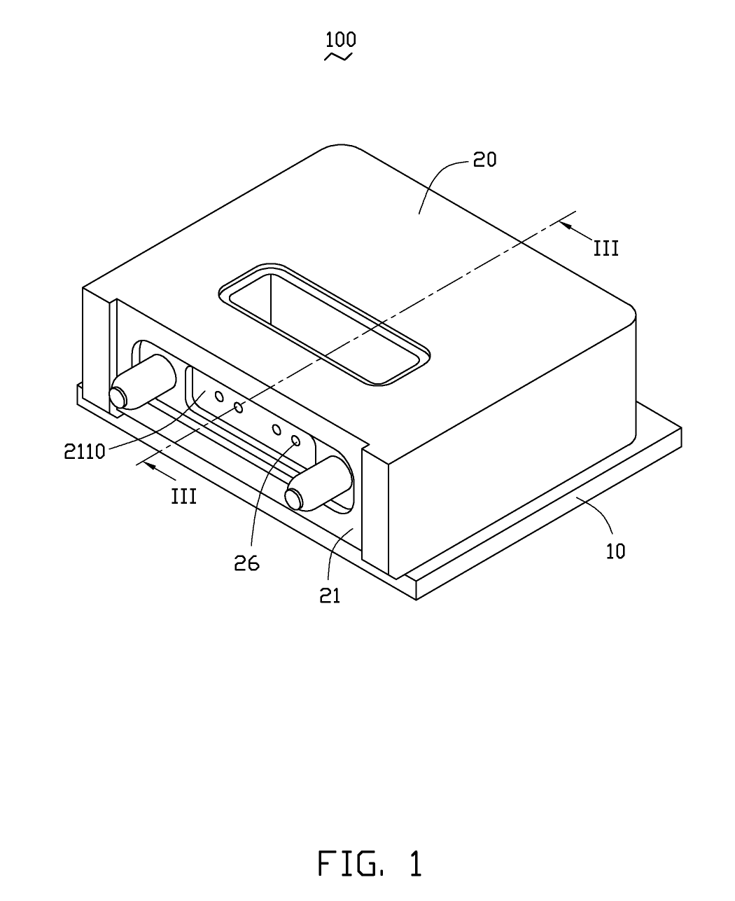

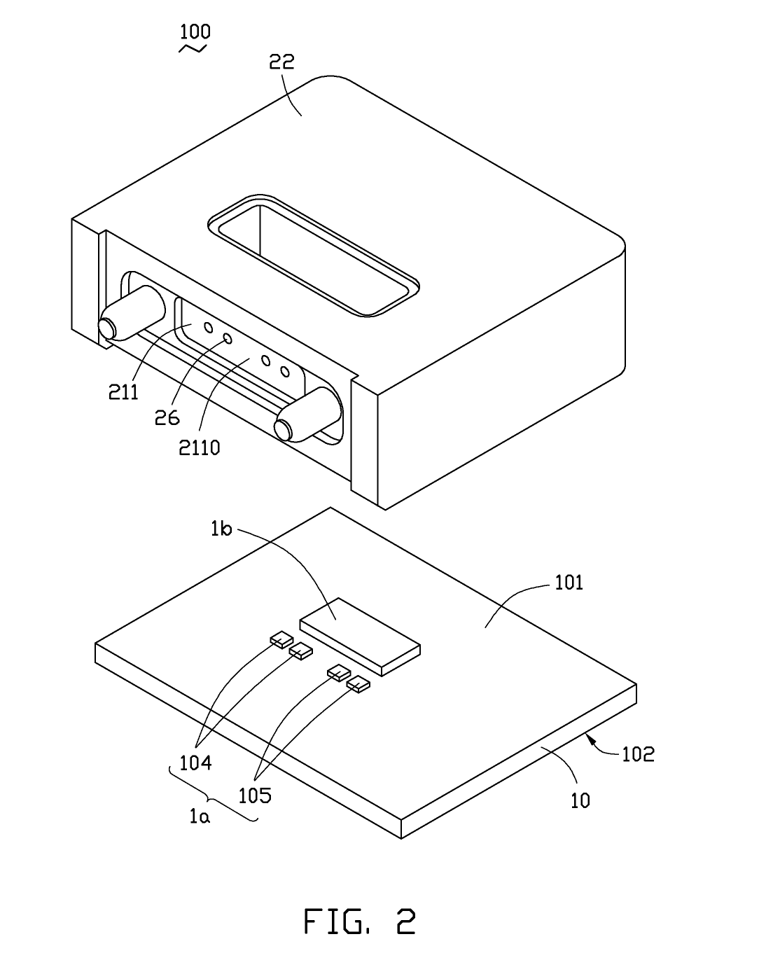

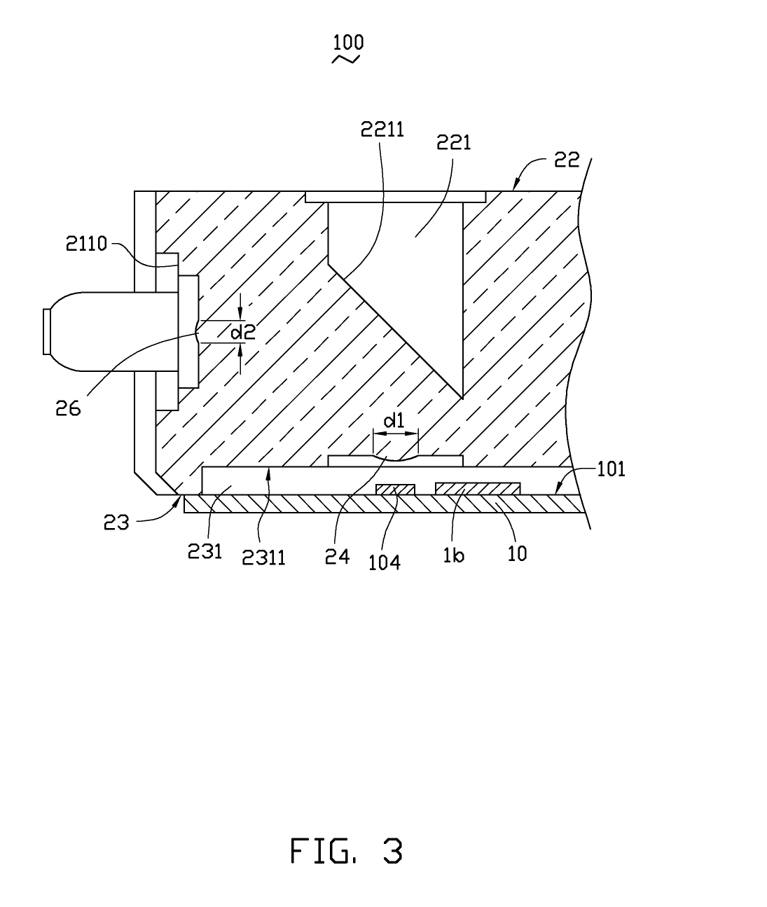

FIGS. 1-3 show an optical-electric converting module 100, according to an embodiment. The optical-electric converting module 100 includes a printed circuit board (PCB) 10 and an optical coupling element 20 positioned on the PCB 10.

The PCB 10 includes a supporting surface 101 and a rear surface 102 facing away from the supporting surface 101. Four photoelectric conversion chips 1a, which in the embodiment are two laser diodes 104 and two photo diodes 105 are positioned on the supporting surface 101. The PCB 10 contains various circuits (not shown) that connect with the two laser diodes 104 and the two photo diodes 105. The PCB 10 also includes a drive chip 1b configured to drive the laser diodes 104 to emit light, and configured to demodulate the data in the light received by the photo diodes 105.

The optical coupling element 20 includes a first side surface 21, an upper surface 22 and a lower surface 23 facing away from the upper surface 22. The upper surface 22 is substantially parallel with the lower surface 23. The first side surface 21 perpendicularly connects the upper surface 22 to the lower surface 23.

The optical coupling element 20 defines a first cavity 231 in the lower surface 23, a bottom portion 2311 of the first cavity 231 forms four first light coupling lenses 24. In the embodiment, all of the first light coupling lenses 24 are convex lenses and are integrally formed with the optical coupling element 20. The lower surface 23 is positioned on the supporting surface 101 of the PCB 10, with the two laser diodes 104, the two photo diodes 105 and the drive chip lb being received in the first cavity 231, such that each of the first light coupling lens 24 aligns with a laser diode 104 or a photo diode 105. In the embodiment, a diameter of the first light coupling lens 24 is equal to d1.

The optical coupling element 20 also defines a second cavity 221 in the upper surface 22. The second cavity 221 includes a reflecting surface 2211. An included angle between the upper surface 22 and the reflecting surface 2211 is about 45 degrees. An included angle between an optical axis of each first light coupling lens 24 and the reflecting surface 2211 is therefore about 45 degrees.

The optical coupling element 20 also defines a receiving cavity 211 in the first side surface 21. The receiving cavity 211 includes a vertical surface 2110 substantially perpendicular to the upper surface 22. The vertical surface 2110 forms four second light coupling lenses 26. In the embodiment, all of the second light coupling lenses 26 are convex lenses and are integrally formed with the optical coupling element 20. An included angle between an optical axis of each the second light coupling lens 26 and the reflecting surface 2211 is also about 45 degrees. Each of the second light coupling lenses 26 optically aligns with to a respective one of the first light coupling lenses 24 via the reflecting surface 2211. In the embodiment, a diameter of the second light coupling lens 26 is equal to d2, and d1>d2.

In use, light emitted from the two laser diodes 104 is directed into the optical coupling element 20 by the two first light coupling lenses 24, and the light path is bent about 90 degrees by the reflecting surface 2211. In the embodiment, the second light coupling lenses 26 are positioned on the light path from the reflecting surface 2211. The light is thus finally reflected into the two optical fibers (not shown) by the second light-emitting coupling lenses 26. A process of the photo diodes 105 receiving light is the reverse of that of the laser diodes 104 emitting light.

In measuring any eccentricity between the first coupling lenses 24 and the second coupling lenses 26, since the diameter of the first light coupling lens 24 is equal to d1 which is larger than the diameter of the second light coupling lens 26 (d2), a camera module (not shown) can capture an image of the second light coupling lens 26 through the first light coupling lenses 24 and the camera module also captures an image of the first light coupling lens 24 at the same time, then measures any eccentricity between the first light coupling lenses 24 and the second light coupling lenses 26, based upon the image of the second light coupling lens 26 and the image of the first light coupling lens 24.

In other embodiments, the numbers of the laser diodes 104, the photo diodes 105, the first light coupling lenses 24 and the second light coupling lenses 26 can be changed depending on need.

In other embodiments, the receiving cavity 211 can be omitted from the optical coupling element 20, and the second light coupling lens 26 are formed directly on the first side surface 21.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. An optical coupling element, comprising:
a lower surface defining a first cavity, the first cavity comprising a bottom portion, the bottom portion forming at least two first light coupling lenses, a diameter of each of the at least two first light coupling lens being equal to d1;
an upper surface facing away from the lower surface, the upper surface defining a second cavity, the second cavity comprising a reflecting surface; and
a side surface perpendicularly connecting to the lower surface, the side surface forming at least two second light coupling lenses, each of the at least two second light coupling lenses optically aligning with a respective one of the at least two first light coupling lenses via the reflecting surface, a diameter of the at least two second light coupling lenses being equal to d2, wherein d1>d2.

2. The optical coupling element of claim 1, wherein the upper surface is substantially parallel with the lower surface.

3. The optical coupling element of claim 1, wherein an included angle between the upper surface and the reflecting surface is about 45 degrees, an included angle between an optical axis of each of the at least two first light coupling lenses and the reflecting surface is about 45 degrees, and an included angle between an optical axis of each of the at least two second light coupling lenses and the reflecting surface is about 45 degrees.

4. The optical coupling element of claim 1, wherein the side surface defines a receiving cavity, the receiving cavity comprises a vertical surface substantially perpendicular to the upper surface, and the at least two second light coupling lenses are formed on the vertical surface.

5. The optical coupling element of claim 1, wherein the at least two first light coupling lenses and the at least two second light coupling lenses are convex lenses and are integrally formed with the optical coupling element.

6. An optical-electric converting module, comprising:
a printed circuit board (PCB) comprising a supporting surface, at least one laser diode and at least one photo diode, the at least one laser diode and the at least one photo diode positioned on the supporting surface and electrically connected to the PCB; and
an optical coupling element comprising:
a lower surface defining a first cavity, the first cavity comprising a bottom portion, the bottom portion forming at least two first light coupling lenses, a diameter of each first light coupling lens being equal to d1;
an upper surface facing away from the lower surface, the upper surface defining a second cavity, the second cavity comprising a reflecting surface; and
a side surface perpendicularly connecting to the lower surface, the side surface forming at least two second light coupling lenses, each of the at least two second light coupling lenses optically aligning with a respective one of the at least two first light coupling lenses via the reflecting surface, the lower surface positioned on the supporting surface, with the at least one laser diode and the at least one photo diode being received in the first cavity, each of the at least two first light coupling lenses aligning with a respective one of the at least one laser diode and the least one photo diode, a diameter of each second light coupling lens being equal to d2, wherein d1>d2.

7. The optical-electric converting module of claim 6, wherein the upper surface is substantially parallel with the lower surface.

8. The optical-electric converting module of claim 6, wherein an included angle between the upper surface and the reflecting surface is about 45 degrees, an included angle between an optical axis of each first light coupling lens and the reflecting surface is about 45 degrees, and an included angle between an optical axis of each second light coupling lens and the reflecting surface is about 45 degrees.

9. The optical-electric converting module of claim 6, wherein the side surface defines a receiving cavity, the receiving cavity comprises a vertical surface substantially perpendicular to the upper surface, and the at least two second light coupling lenses are formed on the vertical surface.

10. The optical-electric converting module of claim 6, wherein the at least two first light coupling lenses and the at least two second light coupling lenses are convex lenses and are integrally formed with the optical coupling element.

11. The optical-electric converting module of claim 6, further comprising a driver chip, wherein the drive chip is received in the first cavity, the drive chip is configured to drive the at least one laser diode to emit light and configured to demodulate data in the light received by the at least one photo diode.
